(19) United States
(12) Patent Application Publication
(10) Pub. No.: US 2020/0271278 A1
(43) Pub. Date: Aug. 27, 2020

(54) LED SOFT STRIP LAMP BULB

(71) Applicant: Dongguan Miray E-Tech Co.,Ltd, Dongguan (CN)

(72) Inventor: Jianwen Lei, Dongguan (CN)

(73) Assignee: Dongguan Miray E-Tech Co.,Ltd

(21) Appl. No.: 16/527,281

(22) Filed: Jul. 31, 2019

(30) Foreign Application Priority Data
Feb. 21, 2019 (CN) 2019/20218965.6

(51) Int. Cl. F21K 9/237; F21K 9/232; F21K 9/238; F21V 23/00; F21V 19/00; F21K 9/66

(52) U.S. Cl. CPC F21K 9/237; F21K 9/232; F21K 9/238; F21Y 2115/10; F21V 23/006; F21V 19/003; F21K 9/66; F21V 23/002

(57) ABSTRACT

A LED soft strip lamp bulb comprising a lamp cap, a lamp shade and an LED light source drive element connected mutually, in which a glass core column is disposed on an upper end of the lamp cap in a protruding manner, the LED light source drive element is installed at an upper, middle, or a lower portion of the glass core column, a bottom of the glass core column and a bottom of the lamp shade are sintered or connected integrally, two conducting wires connected with the lamp cap are disposed on the glass core column, at least one LED soft strip is disposed above the two conducting wires, both ends of the LED soft strip is disposed with welding pins respectively, the two conducting wires are fixedly welded with the welding pins respectively to form an LED luminous body bended in a U or circular shape.

### CROSS-REFERENCES TO RELATED APPLICATIONS

This application claims priority from China Patent Application Serial Number 2019/20218965.6, which was filed on Feb. 21, 2019.

### BACKGROUND OF THE INVENTION

### 1. Technical Field

The present invention relates to the technical field of an LED lamp bulb and in particular to an LED soft strip lamp bulb.

### 2. Background Art

Due to high light emitting efficiency, low heat generation, less power consumption and long service life, an LED light source has been widely applied and gradually replaces traditional lighting apparatuses such as an incandescent lamp and a halogen lamp and so on. However, the incandescent lamps have been widely accepted for its external appearance and light emission effect over a long time, resulting in a high acceptance degree. Thus, the LED lamps will be popular when simulating the external appearances and the light emission effect of the incandescent lamps.

For a common LED lamp bulb, one support is disposed in a glass lamp tube and an LED filament is installed on the support by welding. An ordinary LED filament is formed by an elongated substrate and a plurality of LED chips disposed on the substrate. Because the LED filament is limited in shape due to limitation of the substrate, the requirements for different styles cannot be satisfied.

### SUMMARY OF THE INVENTION

To solve the problem of prior art, the present application provides an LED soft strip lamp bulb.

To overcome the above technical problem, the present application adopts the following technical solution.

An LED soft strip lamp bulb comprises a lamp cap, a lamp shade and an LED light source drive element that are connected mutually. A glass core column is disposed on an upper end of the lamp cap in a protruding manner, the LED light source drive element may be mounted at an upper portion, a middle portion and a lower portion of the glass core column, the bottom of the glass core column and the bottom of the lamp shade are sintered or connected integrally, two conducting wires connected with the lamp cap are disposed on the glass core column, at least one LED soft strip is disposed above the two conducting wires, two ends of the LED soft strip are disposed with welding pins respectively, the two conducting wires and the two welding pins are fixedly welded respectively to form an LED luminous body, and the LED luminous body is bent to be a U shape or a circular shape.

The LED soft strip includes a flexible circuit board, an LED chip and an LED packaging material. The LED chip is packaged on the flexible circuit board by the LED packaging material and the LED chip is electrically connected with the flexible circuit board.

Preferably, an anti-tension strengthening layer is disposed on a bottom surface of the flexible circuit board, and the LED packaging material fully wraps the flexible circuit board and the anti-tension strengthening layer.

The lamp cap is a standard lamp cap which is one of E27, E26, E17, E14, E12 and E10.

The lamp shade is a glass cover or a plastic casing. A color coating is coated on an outer wall or an inner wall of the glass cover or an outer wall or an inner wall of the plastic casing is frosted.

The glass core column includes a glass flare tube, a first conducting wire, a second conducting wire and an exhaust tube. The glass flare tube and the exhaust tube are sintered into a core column body at a high temperature. The first conducting wire and the second conducting wire are fixedly sintered at both sides of the core column body vertically respectively and lower end portions of the first conducting wire and the second conducting wire are fixedly welded on the lamp cap respectively.

The first conducting wire is taken as a negative pole and the second conducting wire is taken as a positive pole. The lower end portion of the first conducting wire is fixed on a side wall of the lamp cap by welding and the lower end portion of the second conducting wire is fixedly welded exactly beneath the lamp cap.

The LED light source drive element may be disposed at an upper portion or a lower portion of the second conducting wire. When the LED light source drive element is disposed at the upper portion of the second conducting wire, the LED light source drive element is located above the top of the glass core column; when the LED light source drive element is disposed at the lower portion of the second conducting wire, the LED light source drive element is located at an inner side of the glass core column or beneath the glass core column.

### Benefits of the Present Invention

The present application provides an LED soft strip lamp bulb in which an LED soft strip is fixedly welded on the conducting wires. Since the LED soft strip may bend or deform, the installation morphology is not limited and thus the LED soft strip may be deformed into different patterns to meet the needs of customers.

### BRIEF DESCRIPTION OF THE DRAWINGS

FIG. 1 is a schematic diagram illustrating a structure of an LED soft strip lamp bulb according to some examples of the present application.

FIG. 2 is a schematic diagram illustrating a structure of a first implementation of an LED lamp core in the present application.

FIG. 3 is a schematic diagram illustrating a second implementation of an LED lamp core in the present application.

FIG. 4 is a schematic diagram illustrating a third implementation of an LED lamp core in the present application.

In the drawings, 1 is a lamp cap, 2, is a lamp shade, 3 is an LED light source drive element, 4 is a glass core column, 5 is an LED soft strip, 6 is a welding pin, 7 is a glass flare tube, 8 is a first conducting wire, 9 is a second conducting wire and 10 is an exhaust tube.

### DETAILED DESCRIPTION OF PREFERRED EMBODIMENTS OF THE INVENTION

To help persons skilled in the art to have a full understanding, the present application will be further described below in detail in combination with examples and accompanying drawings. Contents mentioned in the examples are not limiting of the present application. Detailed descriptions are made below to the present application in combination with accompanying drawings.

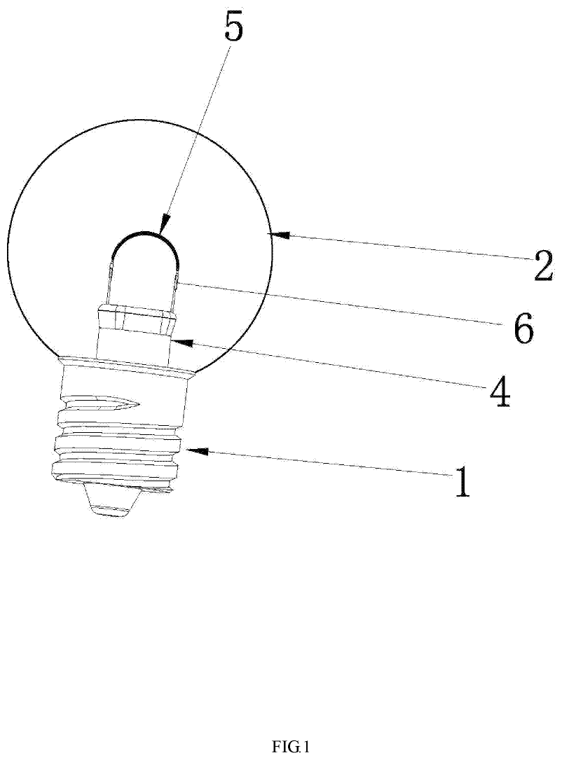

As shown in FIG. 1, the present application provides an LED soft strip lamp bulb. The LED soft strip lamp bulb includes a lamp cap 1, a lamp shade 2 and an LED light source drive element 3 that are mutually connected. A glass core column 4 is disposed on an upper end of the lamp cap 1 in a protruding manner, the LED light source drive element 3 may be mounted at an upper portion, a middle portion and a lower portion of the glass core column 4, the bottom of the glass core column 4 and the bottom of the lamp shade 2 are sintered or connected integrally, two conducting wires connected with the lamp cap 1 are disposed on the glass core column 4, at least one LED soft strip 5 is disposed above the two conducting wires, two ends of the LED soft strip 5 are disposed with welding pins 6 respectively, the two conducting wires and the two welding pins 6 are fixedly welded respectively to form an LED luminous body, and the LED luminous body is bent to be a U shape or a circular shape. Compared with traditional LED lamps, the LED soft strip 5 is fixedly welded on the conducting wires in the LED soft strip lamp bulb. Since the LED soft strip 5 may bend or deform, the installation morphology is not limited and thus the LED soft strip 5 may be deformed into different patterns (for example, a U shape shown in FIG. 1) to meet the needs of customers.

In the present application, the LED soft strip 5 includes a flexible circuit board, an LED chip and an LED packaging material. The LED chip is packaged on the flexible circuit board by the LED packaging material and the LED chip is electrically connected with the flexible circuit board. Preferably, an anti-tension strengthening layer is disposed on a bottom surface of the flexible circuit board, and the LED packaging material fully wraps the flexible circuit board and the anti-tension strengthening layer. The flexible circuit board is connected with a surface of the anti-tension strengthening layer so that the anti-tension strengthening layer and the flexible circuit board will not be damaged even under the action of an external force, thereby improving the reliability of the LED soft strip 5.

In the present application, the lamp cap 1 is a standard lamp cap which is one of E27, E26, E17, E14, E12 and E10.

In the present application, the lamp shade 2 is a glass cover or a plastic casing. A color coating is coated on an outer wall or an inner wall of the glass cover or an outer wall or an inner wall of the plastic casing is frosted. The glass cover or the plastic casing may be colored as long as desired pigments are added to raw materials during a molding process.

In the present application, the glass core column 4 includes a glass flare tube 7, a first conducting wire 8, a second conducting wire 9 and an exhaust tube 10. The glass flare tube 7 and the exhaust tube 10 are sintered into a core column body at a high temperature. The first conducting wire 8 and the second conducting wire 9 are fixedly sintered at both sides of the core column body vertically respectively and lower end portions of the first conducting wire 8 and the second conducting wire 9 are fixedly welded on the lamp cap 1 respectively. Further, the first conducting wire 8 is taken as a negative pole and the second conducting wire 9 is taken as a positive pole. The lower end portion of the first conducting wire 8 is fixedly welded on a side wall of the lamp cap 1 and the lower end portion of the second conducting wire 9 is fixedly welded exactly beneath the lamp cap 1.

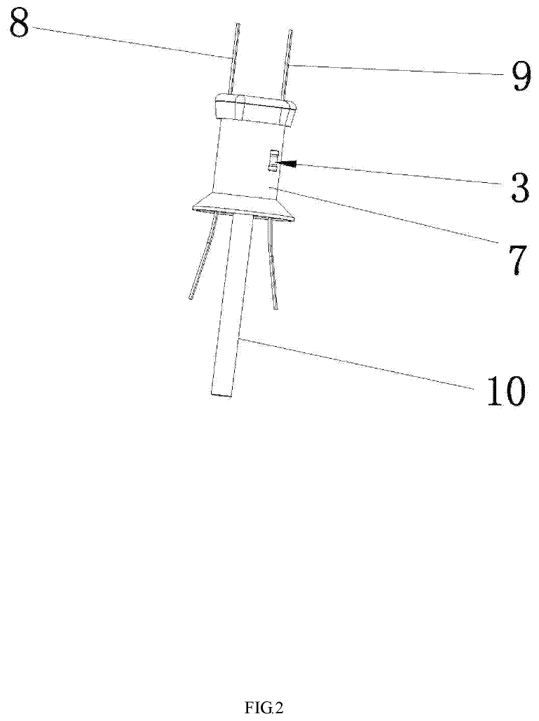

In the present application, the LED light source drive element 3 and the second conducting wire 9 are sintered integrally. Specifically, the LED light source drive element 3 according to the present application is firstly manufactured by an electronic element production machine automatically and sintered with the second conducting wire 9 integrally. The LED light source drive element 3 may be disposed at an upper portion or a lower portion of the second conducting wire 9. When the LED light source drive element 3 is disposed at the upper portion of the second conducting wire 9, the LED light source drive element 3 is located above the top of the glass core column 4; when the LED light source drive element 3 is disposed at the lower portion of the second conducting wire 9, the LED light source drive element 3 is located at an inner side of the glass core column 4 or beneath the glass core column 4. Specifically, the LED soft strip 3 and the glass core column 4 jointly form an LED lamp core. The LED lamp core may have three implementations shown in FIGS. 2-4.

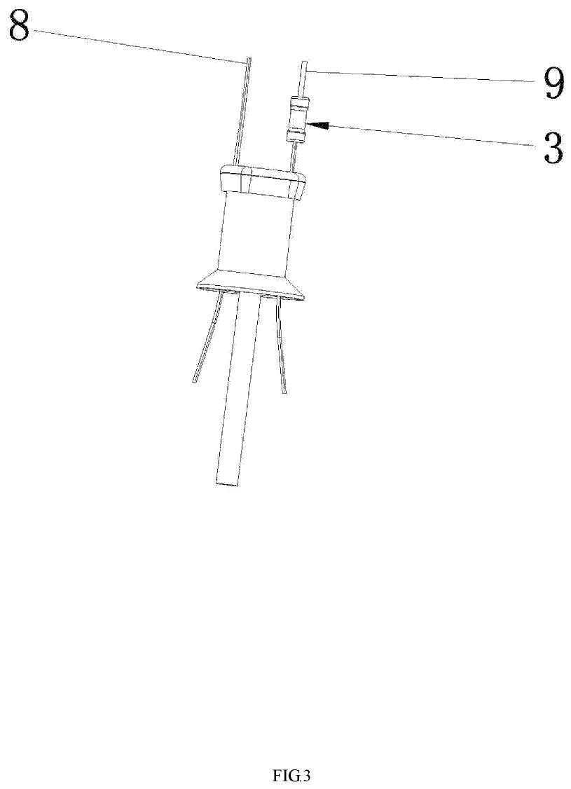

In the first implementation of the LED lamp core, the LED light source drive element 3 is disposed at the lower portion of the second conducting wire 9 and the LED light source drive element 3 is located inside the glass flare tube 7 as shown in FIG. 2. The LED light source drive element 3 is hidden inside and thus the LED light source drive element 3 will not affect the aesthetics of the LED lamp bulb. In the second implementation of the LED lamp core, as shown in FIG. 3, the LED light source drive element 3 may be disposed at the upper portion of the second conducting wire 9 and the LED light source drive element is located above the top of the glass core column 4. In this way, the LED light source drive element 3 can be visually observed from outside the lamp shade 2. In the first and second implementations, the LED light source drive element 3 with a drive chip and a resistance element is preinstalled on the second conducting wire 9 and the LED light source drive element 3 and the second conducting wire 9 are sintered integrally. In this case, a connection form of installing an electronic element in a lamp cap according to the prior art is omitted, the connection structure and manner of the LED light source drive element 3 are optimized, thereby facilitating automatic production, improving production efficiency and greatly reducing the manufacturing costs of the LED lamp bulbs.

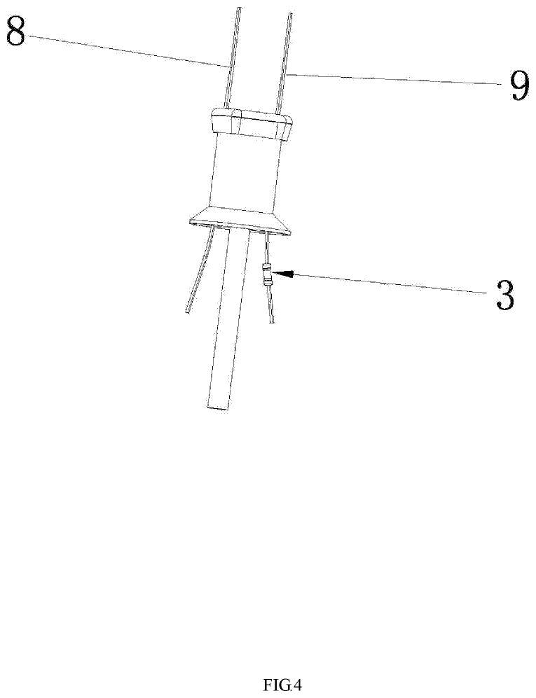

In the third implementation of the LED lamp core, as shown in FIG. 4, the LED light source drive element is disposed at the lower portion of the second conducting wire 9 and the LED light source drive element 3 is located beneath the glass flare tube 7. The LED light source drive element 3 may be welded on the second conducting wire 9 manually. The LED light source drive element 3 may be installed according to the requirements of customers but not limited to the upper and the lower portions of the second conducting wire 9. The power of the LED lamp bulb will not be affected due to the installation position of the LED light source drive element 3.

In conclusion, the above descriptions are merely preferred examples of the present application rather than constitute limitation to the present application in any form. Although the present application is disclosed by the above preferred examples, the present application is not limited to these preferred examples. Any changes or modifications made by those skilled in the art by use of the technical contents disclosed as above without departing from the scope of protection of the present application will be deemed as equivalent examples. Any changes, equivalent changes or modifications made to the above examples without departing from the technical solutions of the present application shall all fall in the scope of protection of the present application.

What is claimed is:

1. An LED soft strip lamp bulb comprising a lamp cap, a lamp shade and an LED light source drive element connected mutually, wherein, a glass core column is disposed on an upper end of the lamp cap in a protruding manner, the LED light source drive element is installed at an upper portion, a middle portion or a lower portion of the glass core column, a bottom of the glass core column and a bottom of the lamp shade are sintered or connected integrally, two conducting wires connected with the lamp cap are disposed on the glass core column, at least one LED soft strip is disposed above the two conducting wires, both ends of the LED soft strip is disposed with welding pins respectively, the two conducting wires are fixedly welded with the welding pins respectively to form an LED luminous body and the LED luminous body bends to be a U shape or a circular shape.

2. The LED soft strip lamp bulb according to claim 1, wherein the LED soft strip comprises a flexible circuit board, an LED chip and an LED packaging material, the LED chip is fixedly packaged on the flexible circuit board by the LED packaging material and the LED chip is electrically connected with the flexible circuit board.

3. The LED soft strip lamp bulb according to claim 2, wherein a bottom surface of the flexible circuit board is disposed with an anti-tension strengthening layer, and the LED packaging material fully wraps the flexible circuit board and the anti-tension strengthening layer.

4. The LED soft strip lamp bulb according to claim 1, wherein the lamp cap is a standard lamp cap which is one of E27, E26, E17, E14, E12 and E10.

5. The LED soft strip lamp bulb according to claim 1, wherein the lamp shade is a glass cover or a plastic casing, and a color coating is coated on an outer wall or an inner wall of the glass cover or an outer wall or an inner wall of the plastic casing is frosted.

6. The LED soft strip lamp bulb according to claim 1, wherein the glass core column comprises a glass flare tube, a first conducting wire, a second conducting wire and an exhaust tube, the glass flare tube and the exhaust tube are sintered into a core column body, the first conducting wire and the second conducting wire are fixedly sintered at both sides of the core column body vertically respectively and lower end portions of the first conducting wire and the second conducting wire are fixedly welded on the lamp cap respectively.

7. The LED soft strip lamp bulb according to claim 6, wherein the first conducting wire is taken as a negative pole and the second conducting wire is taken as a positive pole, the lower end portion of the first conducting wire is fixedly welded on a side wall of the lamp cap and the lower end portion of the second conducting wire is fixedly welded exactly beneath the lamp cap.

8. The LED soft strip lamp bulb according to claim 7, wherein the LED light source drive element sintered with the second conducting wire integrally, the LED light source drive element is disposed at an upper portion, or a middle lower portion of the second conducting wire; when the LED light source drive element is disposed at the upper portion of the second conducting wire, the LED light source drive element is located above the top of the glass core column; when the LED light source drive element is disposed at the middle lower portion of the second conducting wire, the LED light source drive element is located at an inner side of the glass core column or beneath the glass core column.

9. The LED soft strip lamp bulb according to claim 6, wherein the LED light source drive element is disposed and sintered at the upper, middle or lower portion of the glass flare tube to manufacture one complete core column.
